(19) United States
(12) Patent Application Publication
(10) Pub. No.: US 2004/0049413 A1
(43) Pub. Date: Mar. 11, 2004

(54) Apparatus, method, and computer program for reservation of accommodation

(75) Inventors: Hitoshi Momma, Kawasaki (JP); Yuji Kawata, Kawasaki (JP); Daisuke Hoki, Kawasaki (JP); Satoshi Nagai, Kawasaki (JP); Jin Kure, Kawasaki (JP); Iori Takeda, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/634,789

(22) Filed: Aug. 6, 2003

(30) Foreign Application Priority Data
Sep. 9, 2002 (JP) 2002-263233

(51) Int. Cl. G06F 17/60

(52) U.S. Cl. 705/5

(57) ABSTRACT

A feedback collecting section obtains from an employee feedback on a hotel based on his or her previous personal experience about the hotel, a favorites processing section provides information relating to the employee's favorite hotels, a recommendation processing section provides information relating to recommended hotels selected based on the employee feedback, and a room availability inquiring section provides a list of available rooms that is created by a travel agent website by adding to it the employee feedback.

### BACKGROUND OF THE INVENTION

1) Field of the Invention

The present invention relates to an apparatus, a method, and a computer program for reserving a desired room in a hotel or the like.

2) Description of the Related Art

The Internet is being widely used for inquiring room availability and reserving a suitable room. Room reservation at a hotel can be done simply by accessing the homepage of the hotel and entering relevant details such as the period for which the guest wants to book a room, the room preference, the guest's name, and so on.

A travel agent's homepage usually has hotels listed region-wise, or links to homepages of various hotels. Many of these homepages even offer helpful information in the form of bulletin boards that display customer feedback of various hotels.

A similar service of taking care of hotel reservation for company personnel undertaking business travel is offered as one of its services by the corporate portal services of various business houses (see non-patent literature Momma, “Corporate Portal Service: B-Front”, Fujitsu, August 2002, Vol. 53, No. 4, p. 299-303). These portal services provide links to the homepages of various travel agents. The user can access these sites and make hotel reservation to suit his or her requirement.

However, most of the travel agents provide information that relates to tourist-oriented hotels. This poses a problem when looking for information that relates to business-centric hotels. For example, a business person would prefer a hotel that is close to the place of business because a hotel that is close to a tourist spot need not necessarily be convenient for the business stay.

This implies that the information regarding hotels provided by a travel agent should be segregated into two groups—tourist-oriented information and business-oriented information. However, the percentage of people who seek business-oriented information is far less than that of people who seek tourist-oriented information. Consequently, it usually does not make good financial sense for a travel agency to invest in developing an information system to cater to what is a minority group.

### SUMMARY OF THE INVENTION

It is an object of the present invention to solve at least the problems in the conventional technology.

The accommodation reservation apparatus according to one aspect of the present invention offers information about availability of a room in a hotel in response to a request by a user, and reserves the room selected by the user. The accommodation reservation apparatus comprises a feedback collecting unit that obtains from the user a feedback about an evaluation of the hotel or the room based on the user's previous personal experience at the hotel; and a room availability information providing unit that provides the user the feedback along with the information about availability of the room.

The method according to another aspect of the present invention is a method of offering information about availability of a room in a hotel in response to a request by a user, and reserving the room selected by the user. The method comprises collecting from the user a feedback about an evaluation of the hotel or the room based on the user's previous personal experience at the hotel; and providing the user the feedback along with the information about availability of the room.

The computer program according to still another aspect of the present invention realizes the method according to the present invention on a computer.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a block diagram that shows the structure of an accommodation reservation system according to the present invention;

FIG. 2 shows sample contents of a favorites storing section;

FIG. 3 shows sample contents of a recommendation storing section;

FIG. 4 shows sample contents of a feedback storing section;

FIG. 5 shows sample contents of an employee information storing section;

FIG. 6 is a flowchart that explains an accommodation reservation process in the accommodation reservation server shown in FIG. 1;

FIG. 7 is a flowchart that explains the operations of the room availability inquiring section shown in FIG. 1;

FIG. 8 is a flowchart that explains the steps of available room list creating process shown in FIG. 7;

FIG. 9 is a flowchart that explains the operation of the reserving section shown in FIG. 1; and

FIG. 10 is a flowchart that explains the operation of the feedback collecting section shown in FIG. 1.

### DETAILED DESCRIPTION

Exemplary embodiments of the present invention are described next with reference to the accompanying drawings.

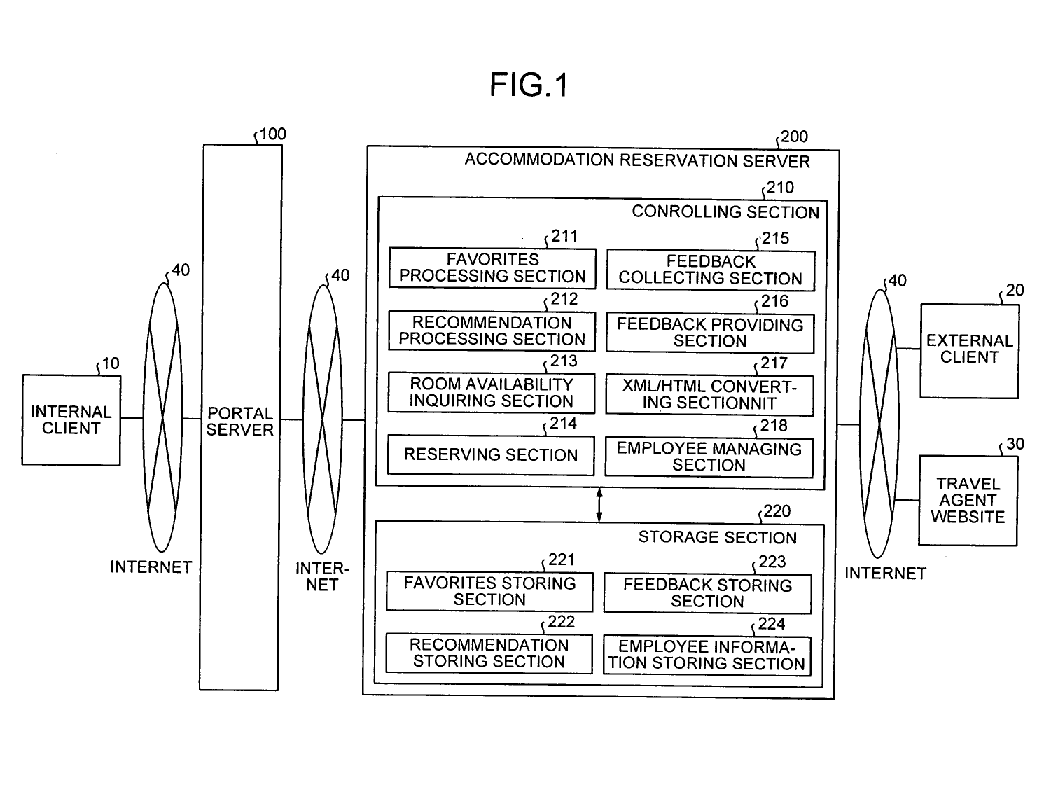

The structure of an accommodation reservation system according to the present invention is explained next with reference to FIG. 1.

The accommodation reservation system comprises a portal server 100 and an accommodation reservation server 200 mutually connected via the Internet 40. An internal client 10 is connected to the portal server 100 via the Internet 40. An external client 20, and a travel agent website 30 are connected to the accommodation reservation server 200 via the Internet 40.

This accommodation reservation system is business travel-oriented and is actually a system built by adding a company employee personal feedback function to the general purpose accommodation reservation function offered by the travel agent website 30.

The internal client 10 is a terminal via which the user accesses the accommodation reservation system using the Internet 40. The internal client 10 can be a personal computer or a personal digital assistant (PDA) on which a web browser is installed.

The external client 20 is a terminal via which travel agency personnel or hotel personnel access the accommodation reservation system using the Internet 40. The external client 20 is a personal computer on which a web browser is installed. This accommodation reservation system collects feedback on various hotels from business personnel and provides the feedback to the concerned travel agents and hotels. The travel agency personnel or the hotel personnel can obtain the feedback from the accommodation reservation system using the external client 20.

The travel agent website 30 is a computer that the travel agency uses. Based on the request from the accommodation reservation system, the travel agent website 30 provides room availability information or carries out hotel booking.

For the sake of convenience, only one each of the internal client 10, the external client 20, the travel agent website 30, and the portal server 100 are shown here. However, this accommodation reservation system allows any number of these machines to be connected.

The portal server 100 functions as a portal site for the company employee and relays hotel reservation related data from the internal client 10 to the accommodation reservation server 200 and vice versa. In other words, the portal server 100 receives data in HTML format from the internal client 10, converts it to XML format and sends it to the accommodation reservation server 200. Similarly, the portal server 100 receives data in XML format from the accommodation reservation server 200, converts it to HTML format and sends it to the internal client 10.

The accommodation reservation server 200 is a computer that receives an accommodation reservation request from the internal client via the portal server, and carries out accommodation reservation using the travel agent website 30. The accommodation reservation server 200 also provides employee feedback information to the external client 20.

The accommodation reservation server 200 comprises a controlling section 210 and a storage section 220. The controlling section 210 carries out processes in response to request from the internal client 10 and the external client 20. The controlling section 210 further comprises a favorites processing section 211, a recommendation processing section 212, a room availability inquiring section 213, a reserving section 214, a feedback collecting section 215, a feedback providing section 216, an XML/HTML converting section 217, and an employee managing section 218.

The storage section 220 stores data used by each of the sections in the controlling section 210, and comprises a favorites storing section 221, a recommendation storing section 222, a feedback storing section 223, and an employee information storing section 224.

The favorites processing section 211 manages a list of favorite hotels from amongst the hotels at which the employees have stayed. The favorites processing section 211 stores hotels specified as favorites by employees in the favorites storing section 221 and searches the hotels stored in the favorites storing section 221 for hotels that satisfy specific criteria.

The recommendation processing section 212 manages, based on the employee feedback on hotels the employees have stayed at, a list of hotels that can be recommended to the employees. The recommendation processing section 212 stores the names of the recommended hotels in the recommendation storing section 222, and searches the recommendation storing section 222 for hotels that satisfy specific criteria.

The employee-recommended hotels are further grouped into hotels based on feedback from all employees and hotels classified according to department-wise feedback. If there is a list of recommended hotels based on the feedback from the department the employee belongs to, the recommendation processing section 212 searches those hotels. If there are no recommended hotels based on the feedback from the department the employee belongs to, the recommendation processing section 212 searches the hotels recommended based on the feedback from all the employees.

In this manner, by managing the department-wise hotel lists, the recommendation processing section 212 enables an employee to look for hotels most suited to his or her requirements based on the feedback from other employees in his or her department.

The room availability inquiring section 213 inquires for room availability at the travel agent website 30 via the Internet 40, and transmits to the portal server 100 the hotels at which rooms are available, along with the employees' personal feedback of the hotels.

Further, if there is available feedback from other employees from the department to which the employee who is reserving a hotel belongs, only the feedback of the employees from that department are relayed. If there is no feedback from other employees from that department, the feedback of all the employees is relayed.

In this manner, by furnishing the department-wise employee feedback to the room availability inquiry result, the room availability inquiring section 213 enables an employee to select a hotel most suited to his or her requirements.

The reserving section 214 reserves a room in the hotel the employee selects based on the room availability inquiry result and carries out the actual reservation by requesting the travel agent website 30.

The feedback collecting section 215 obtains feedback on hotels from the employees and stores the feedback in the feedback storing section 223. In other words, the feedback collecting section 215 collects the feedback of employees on hotels they stayed at based on their personal experience.

In this manner, by collecting feedback from the employees, the feedback collecting section 215 enables evaluation of hotels by the company employees, a feature which the travel agent website 30 by itself cannot provide.

The feedback providing section 216 provides employee feedback on hotels to the external client 20 via the Internet 40 and processes the information stored in the feedback storing section 223 before providing it to the external client 20.

The XML/HTML converting section 217 converts XML data to HTML data and vice versa to facilitate data exchange. The XML/HTML converting section 217 allows data exchange between the internal client 10 and the external client 20 as well as the travel agent website 30 by converting the data to HTML format, and data exchange within the accommodation reservation system by converting the data to XML format.

The employee managing section 218 manages the data relating to the employees who use the accommodation reservation system. The employee managing section 218 stores the data relating to the employees in the employee information storing section 224 and carries out search on employees stored in the employee information storing section 224.

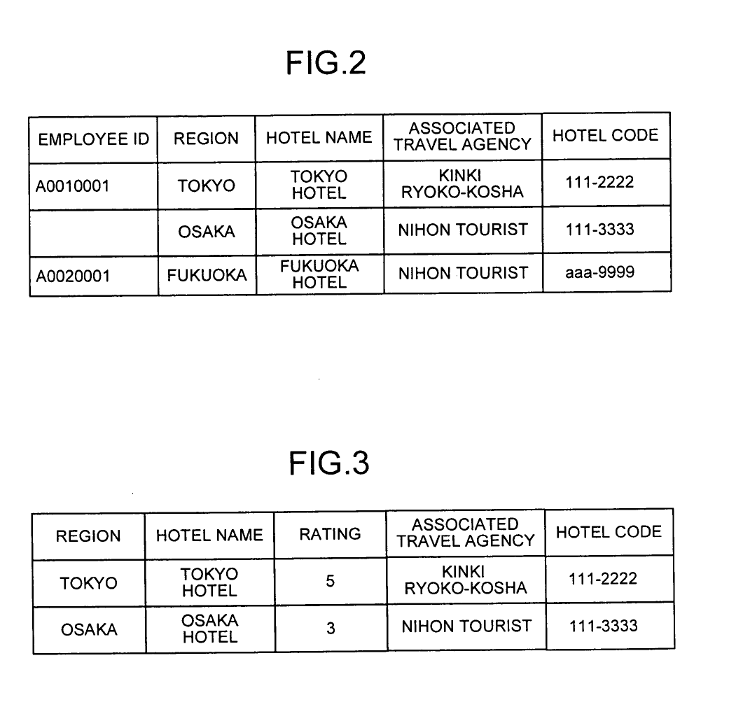

FIG. 2 shows sample contents of the favorites storing section 221. For each employee, the employee's ID and the employee's favorite hotel(s) are stored in a correlated form in the favorites storing section 221. The favorite hotel includes details such as the region, the name of the hotel, associated travel agency, and the hotel code.

The recommendation storing section 222 stores recommended hotels categorizing them region-wise. FIG. 3 shows sample contents of the recommendation storing section 222. The information about recommended hotels is stored in a correlated form with the name of the region, and includes details such as the name of the hotel, rating, associated travel agency, and hotel code.

The rating is a point given to a hotel based on the feedback of an employee received by the feedback collecting section 215. The recommendation storing section 222 stores a list of recommended hotels based on the feedback from all the employees and lists of recommended hotels based on the feedback received department-wise.

In this manner, by storing lists of recommended hotels based on department-wise employee feedback, the recommendation storing section 222 enables the accommodation reservation system to provide a list of recommended hotels to suit every employee.

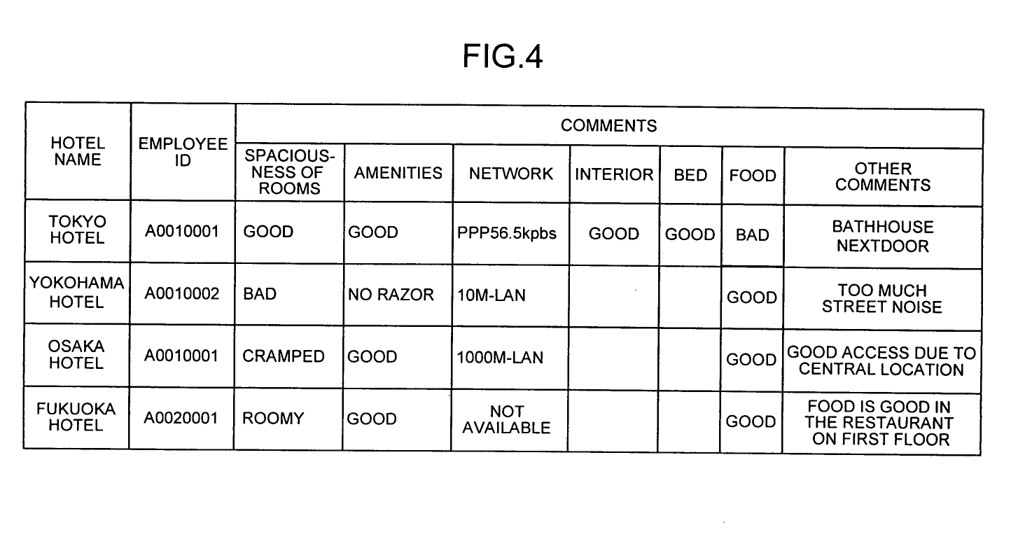

FIG. 4 shows sample contents of the feedback storing section 223. The feedback storing section 223 stores in a correlated form the hotel name and the employee feedback on the hotel obtained by the feedback collecting section 215. The feedback includes details such as, the employee ID, spaciousness of the room, amenities, network, interior, and other comments.

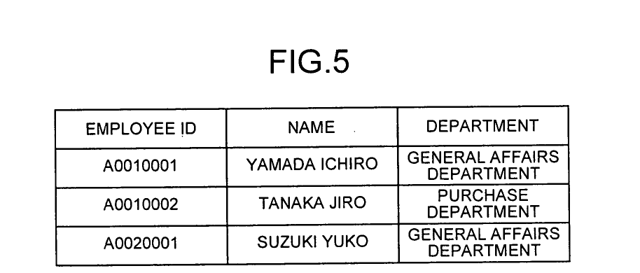

FIG. 5 shows sample contents of the employee information storing section 224. The employee information storing section 224 stores in a correlated form the employee-related information that an employee enters and the employee managing section 218 collects. The employee information includes the employee ID, the employee name and the department to which the employee belongs.

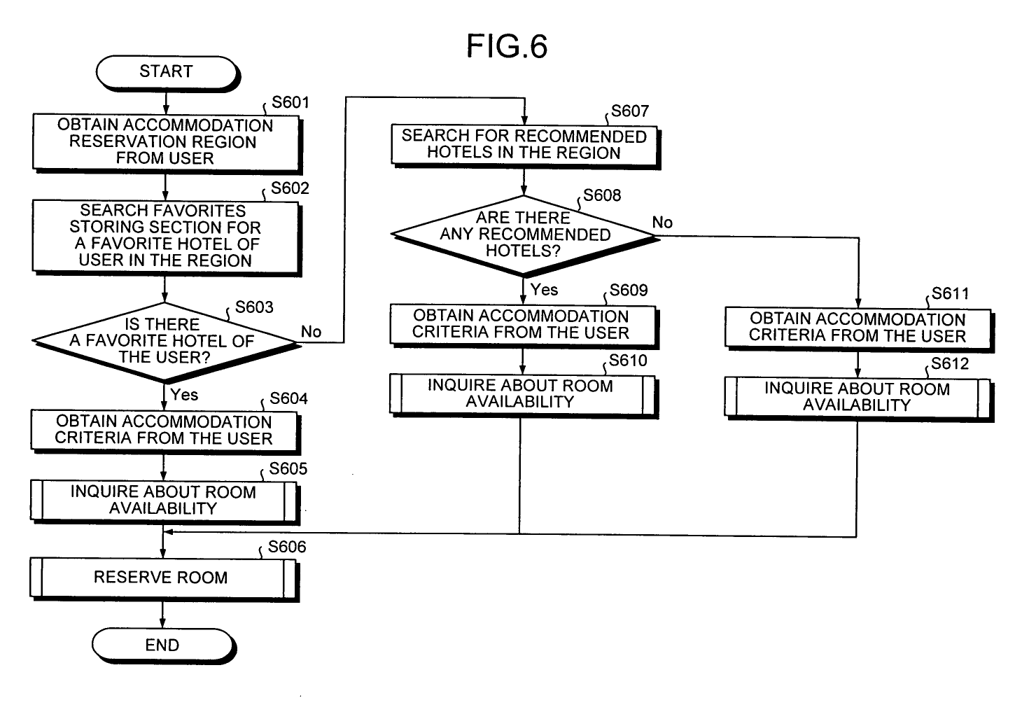

The series of operations of the accommodation reservation process that takes place in the accommodation reservation server 200 shown in FIG. 1 is explained next with reference to the flowchart shown in FIG. 6.

The accommodation reservation server 200 receives from a user a region where accommodation is to be reserved (step S601). The favorites processing section 211 searches the favorites storing section 221 for hotels that are the user's favorite in the region (steps S602 and S603).

If there are hotels that are the user's favorite (Yes at step S603), accommodation criteria are obtained from the user (step S604). The room availability inquiring section 213 specifies a favorite hotel and the accommodation criteria, inquires about room availability using the travel agent website 30 (step S605), and provides the user the result of the inquiry. The reserving section 214 receives the request to reserve from the user, and reserves the accommodation using the travel agent website 30 (step S606).

If no favorite hotel is specified (No at step S603), the recommendation processing section 212 searches the recommendation storing section 222 for recommended hotels in the region specified by the user (steps 607 and 608). If there are hotels recommended by the other employees of the department to which the user belongs, the recommendation processing section 212 limits its search to those hotels, and if not, the recommendation processing section 212 searches the hotels recommended by all the employees.

If there are recommended hotels (Yes at step S608), accommodation criteria are obtained from the user (step S609). The room availability inquiring section 213 specifies a recommended hotel and the accommodation criteria, inquires about room availability using the travel agent website 30 (step S610), and provides the user the result of the inquiry. The reserving section 214 receives the request to reserve from the user, and reserves the accommodation using the travel agent website 30 (step S606).

If there are no recommended hotels (No at step S608), accommodation criteria are obtained from the user (step S611). The room availability inquiring section 213 specifies only accommodation criteria, inquires about room availability using the travel agent website 30 (step S612), and provides the user the result of the inquiry. The reserving section 214 receives the request to reserve from the user, and reserves the accommodation using the travel agent website 30 (step S606).

In this manner, by inquiring about room availability using the feedback based on the employees' previous experience, the favorites processing section 211 and the recommendation processing section 212 of the accommodation reservation server 200 enable the user to efficiently reserve a hotel to suit his or her requirements.

The accommodation reservation for a user is further customized because of the search conducted by the recommendation processing section 212 based on department-wise feedback.

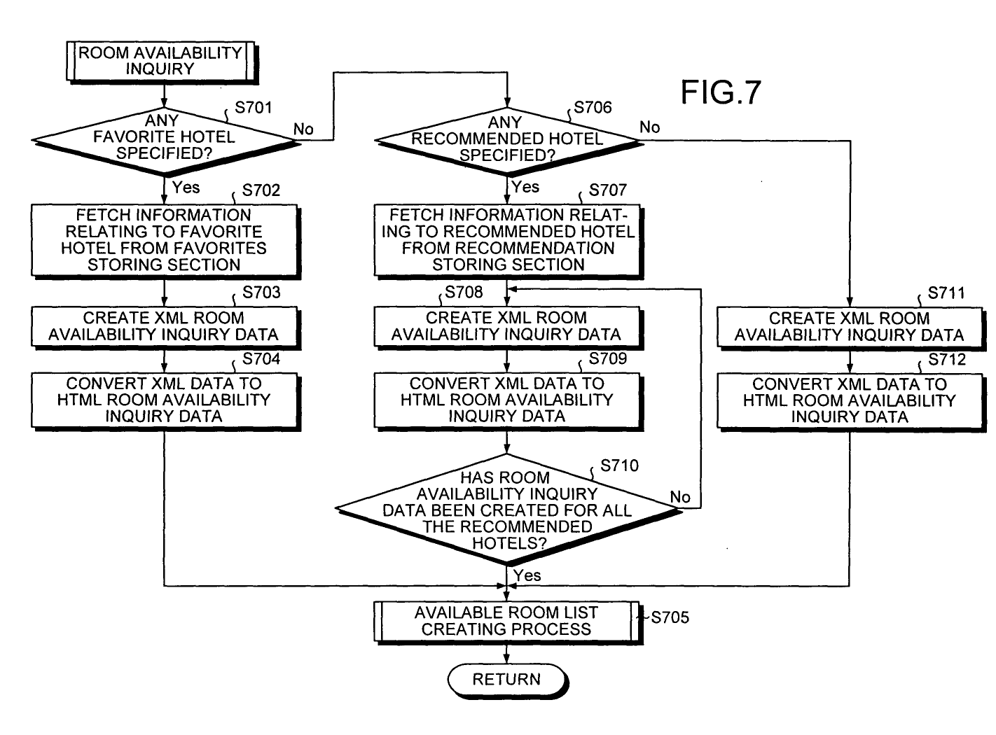

The series of operations of the room availability inquiring section 213 is explained next with the help of the flowchart shown in FIG. 7. The process of the room availability inquiring section 213 corresponds to the room availability inquiry (steps S605, S610, and S612) process in FIG. 6.

The room availability inquiring section 213 checks if any favorite hotel is specified (step S701). If a favorite hotel is specified (Yes at step S701), the room availability inquiring section 213 fetches information relating to the favorite hotel from the favorites storing section 221 (step S702), and creates an XML room availability inquiry data (S703).

The XML room availability inquiry data is converted to an HTML room availability inquiry data by the XML/HTML converting section 217 and sent to the travel agent website 30 (step S704). A list of available rooms is created using available room list creating process (step S705).

If no favorite hotel is specified (No at step S701), the room availability inquiring section 213 checks if any recommended hotel is specified (step S706). If recommended hotels are specified (Yes at step S706), the room availability inquiring section 213 fetches information relating to the recommended hotel from the recommendation storing section 222 (step S707), and creates an XML room availability inquiry data (step S708).

The XML/HTML converting section 217 converts the XML room availability inquiry data to an HTML room availability inquiry data and sends it to the travel agent website 30 (step S709). Next, the room availability inquiring section 213 checks if room availability inquiry data has been created for all the recommended hotels (step S710).

If room availability inquiry data has been created for all the recommended hotels (Yes at step S710), a list of available rooms is created using the available room list creating process (step S705). If room availability inquiring data has not been created for all the recommended hotels (No at step S710), the process returns to step S708 to create the next XML room availability inquiry data.

If no recommended hotels are specified (No at step S706), an XML room availability inquiry data is created (step S711) without any hotel specification, and the XML data is converted to an HTML room availability inquiry data by the XML/HTML converting section 217 and sent to the travel agent website 30 (step S712). A list of available rooms is created using the available room list creating process (step S705).

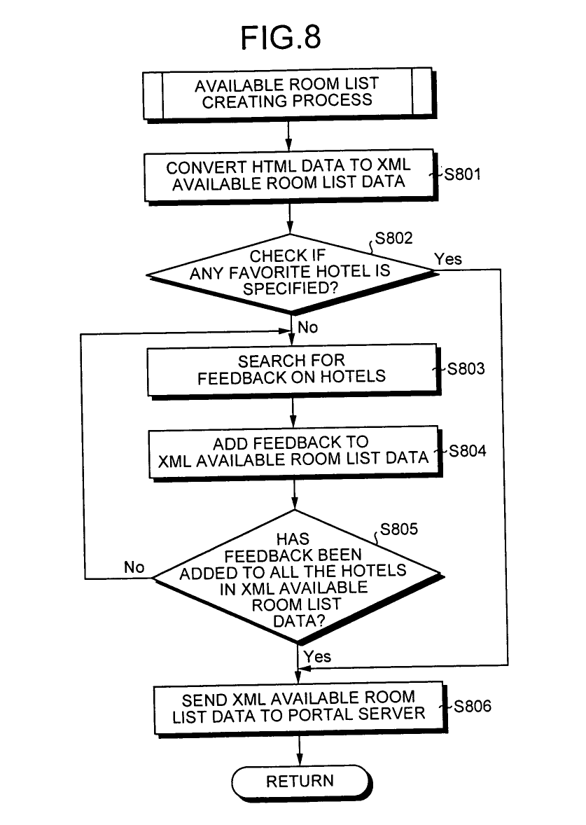

The available room list creating process (step S705) is explained in detail with reference to the flowchart shown in FIG. 8.

In the available room list creating process, the HTML available room list data received from the travel agent website 30 is converted to an XML available room list data (step S801) using the XML/HTML converting section 217. It is then checked whether the XML data pertains to a favorite hotel (step S802) and if so, the XML data is sent to the portal server 100 (step S806).

If the XML data does not pertain to a favorite hotel (No at step S802), the feedback on hotels in the feedback storing section 223 is searched (step S803), and the feedback is added to the XML available room list data (step S804). If feedback from the user's department is available, only that feedback is added to the XML available room list data.

It is then checked if feedback on all the hotels in the XML available room list data has been added (step S805). If so, the XML available room list data is sent to the portal server 100 (step S806). If not (No at step S805), the process returns to step S803 to search for feedback on the next hotel on the list.

In this manner, the available room list creating process makes the search by the user more specific and customized, by sending to the portal server 100 the available room list data created by the travel agent website 30 with feedback of employees added to it. Further, the search is made even more specific by making available department-wise feedback.

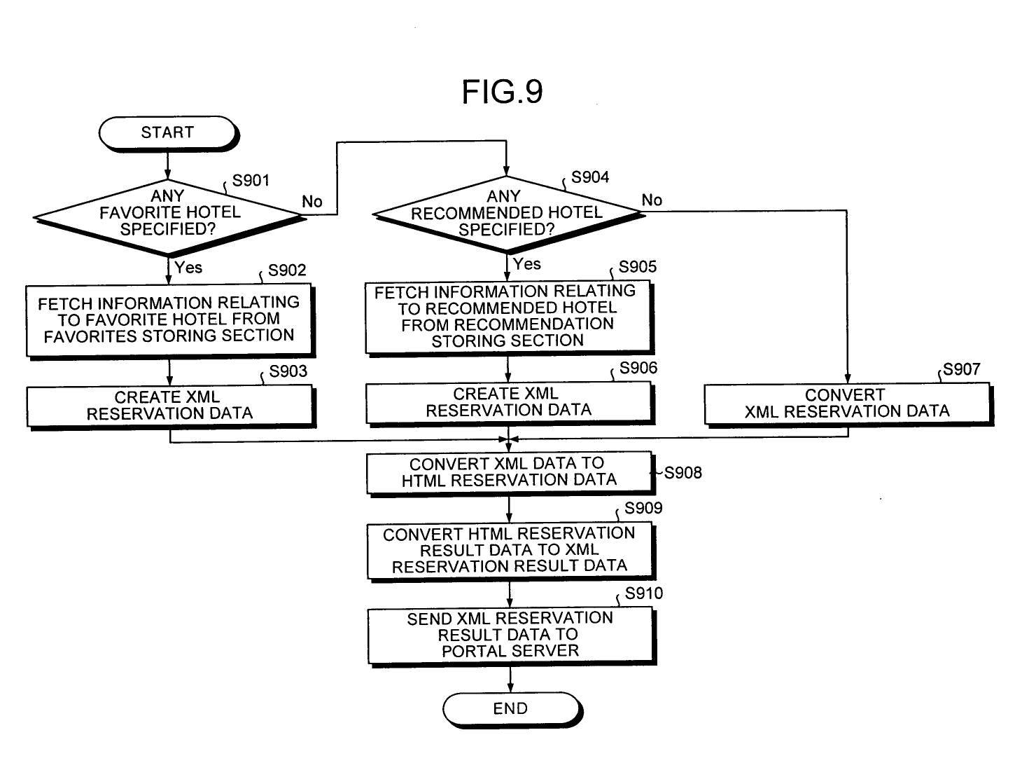

The operation of the reserving section 214 of FIG. 1 is explained next with reference to the flowchart in FIG. 9. The reserving section 214 first checks if a favorite hotel is specified (step S901). If a favorite hotel is specified, the reserving section 214 fetches the information relating to the favorite hotel from the favorites storing section 221 (step S902) and creates an XML reservation data (step S903).

The XML reservation data is converted to an HTML reservation data by the XML/HTML converting section 217 (step S908). The HTML reservation data is then sent to the travel agent website 30 and reservation requested. An HTML reservation result data is received from the travel agent website 30, converted to an XML reservation result data (step S909), and the XML reservation data is sent to the portal server 100 (step S910).

If no favorite hotel is specified (No at step S901), the reserving section 214 checks if there are any recommended hotels specified (step S904), and if so, fetches information relating to recommended hotels from the recommendation storing section 222 (step S905), and creates an XML reservation data (step S906).

The XML reservation data is converted to an HTML reservation data by the XML/HTML converting section 217 (step S908). The HTML reservation data is then sent to the travel agent website 30 and reservation requested. An HTML reservation result data is received from the travel agent website 30, converted to an XML reservation result data (step S909), and the XML reservation data is sent to the portal server 100 (step S910).

If no recommended hotels are specified (No at step S904), an XML reservation data for the hotel specified by the user is created (step S907). The XML reservation data is converted to an HTML reservation data by the XML/HTML converting section 217 (step S908), the HTML reservation data is sent to the travel agent website 30 and reservation requested. An HTML reservation result data is received from the travel agent website 30, converted to an XML reservation result data (step S909), and sent to the portal server 100 (step S910).

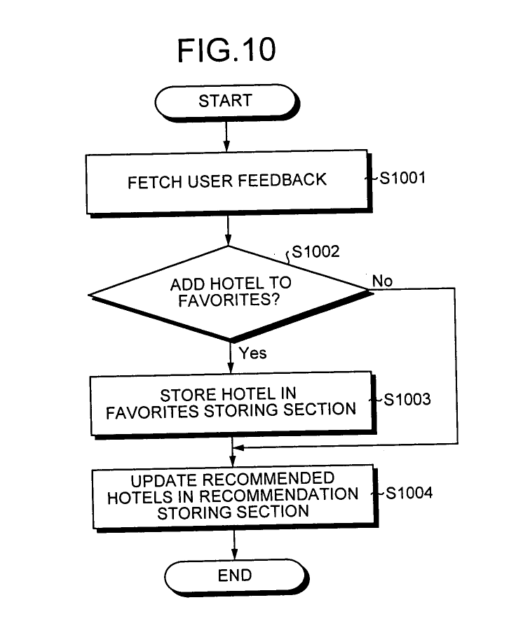

The operations of the feedback collecting section 215 of FIG. 1 are explained next with reference to the flowchart shown in FIG. 10. The feedback collecting section 215 first fetches the feedback on hotels a user enters (step S1001) and stores the feedback in the feedback storing section 223.

The next step is to inquire the user if the hotel is to be entered in the favorites (step S1002). If the user indicates that the hotel is to be entered in the favorites, the hotel is stored in the favorites storing section 221 using the favorites processing section 211 (step S1003).

The hotel is then rated using the feedback stored in the feedback storing section 223, and based on the rating result, the recommended hotels in the recommendation storing section 222 are updated (step S1004).

In this manner, the feedback collecting section 215, collects and stores in the feedback storing section 223 the feedback on hotels from employees based on their personal experience, thereby enabling another employee to select a hotel based on the feedback of employees who have actually stayed at the hotel.

To sum up, according to the present invention, the feedback collecting section 215 collects feedback based on actual personal experience of employees, the recommendation processing section 212 furnishes information relating to recommended hotels based on the employee feedback, and the room availability inquiring section 213 provides the user an available room list created by the travel agent website 30 along with feedback of respective hotels. Therefore, the employee can make a more personalized choice for his or her hotel accommodation.

The implementation of the invention need not be limited to just one company, as explained here, but may have portal servers of a plurality of companies connected to the accommodation reservation server 200 via the Internet. The accommodation reservation system in such a case may be made to provide information customized company-wise instead of department-wise.

The present invention as implemented on an independent accommodation reservation system is explained here. However, the present invention can also be offered as a part of a corporate travel management system.

According to the present invention, feedback on hotels is collected from the users based on their personal experience and the feedback is provided to the user along with the room availability information. In this way, customized information regarding room availability is provided and the accommodation reservation process made more efficient.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An accommodation reservation apparatus that offers information about availability of a room in a hotel in response to a request by a user, and reserves the room selected by the user, the accommodation reservation apparatus comprising:
a feedback collecting unit that obtains from the user a feedback about an evaluation of the hotel or the room based on the user's previous personal experience at the hotel; and
a room availability information providing unit that provides the user the feedback along with the information about availability of the room.

2. The accommodation reservation apparatus according to claim 1, further comprising a recommended accommodation extracting unit that extracts a hotel as a recommended hotel based on the feedback, wherein
the room availability information providing unit preferentially provides the information about availability of the room relating to the recommended hotel over other hotels.

3. The accommodation reservation apparatus according to claim 1, further comprising:
a user affiliation information storing unit that stores in a correlated form the user and a group to which the user belongs as user affiliation information; and
a feedback classifying unit that classifies, based on the user affiliation information, the feedback obtained from users belonging to each group as group-wise feedback, wherein
the room availability information providing unit provides the user the group-wise feedback relating to the group to which the user belongs along with the information about availability of the room.

4. The accommodation reservation apparatus according to claim 3, wherein the group is an organization where the user works.

5. The accommodation reservation apparatus according to claim 1, wherein the feedback collecting unit obtains the feedback from the user, the room availability information providing unit provides the feedback and the information about availability of the room to the user, over the Internet.

6. The accommodation reservation apparatus according to claim 1, further comprising an inputting unit which receives the feedback from the user and transmits the feedback to the feedback collecting unit over the Internet.

7. A method of offering information about availability of a room in a hotel in response to a request by a user, and reserving the room selected by the user, the method comprising:
collecting from the user a feedback about an evaluation of the hotel or the room based on the user's previous personal experience at the hotel; and
providing the user the feedback along with the information about availability of the room.

8. The method according to claim 7, further comprising extracting a hotel as a recommended hotel based on the feedback, wherein
at the providing, the information about availability of the room relating to the recommended hotel is preferentially provided over other hotels.

9. The method according to claim 7, further comprising:
storing, in a correlated form, the user and a group to which the user belongs as user affiliation information; and
classifying, based on the user affiliation information, the feedback obtained from users belonging to each group as group-wise feedback, wherein
at the providing, the group-wise feedback relating to the group to which the user belongs is provided to the user along with the information about availability of the room

10. The method according to claim 7, wherein collection of the feedback and provision of the feedback along with the information about availability of the room are performed over the Internet.

11. The method according to claim 7, further comprising receiving the feedback from the user over the Internet.

12. A computer program containing instructions which when executed on a computer causing the computer to offer information about availability of a room in a hotel in response to a request by a user, and reserve the room selected by the user, the computer program further causing the computer to execute:
collecting from the user a feedback about an evaluation of the hotel or the room based on the user's personal previous experience at the hotel; and
providing the user the feedback along with the information about availability of the room.

13. The computer program according to claim 12, further causes the computer to execute extracting a hotel as a recommended hotel based on the feedback, wherein
at the providing, the information about availability of the room relating to the recommended hotel is preferentially provided over other hotels.

14. The computer program according to claim 12, further causes the computer to execute:
storing, in a correlated form, the user and a group to which the user belongs as user affiliation information; and
classifying, based on the user affiliation information, the feedback obtained from users belonging to each group as group-wise feedback, wherein
at the providing, the group-wise feedback relating to the group to which the user belongs is provided to the user along with the information about availability of the room.

15. The computer program according to claim 12, wherein collection of the feedback and provision of the feedback along with the information about availability of the room are performed over the Internet.

16. The computer program according to claim 12, further comprising receiving the feedback from the user over the Internet.
